(19) United States
(12) Patent Application Publication
(10) Pub. No.: US 2024/0061551 A1
(43) Pub. Date: Feb. 22, 2024

(54) Assistive Communication Using Word Trees

(71) Applicant: 2542202 ONTARIO INC., East York (CA)

(72) Inventor: Ling Ly Tan, East York (CA)

(21) Appl. No.: 18/452,469

(22) Filed: Aug. 18, 2023

Related U.S. Application Data
(60) Provisional application No. 63/399,282, filed on Aug. 19, 2022.

(51) Int. Cl. G06F 3/0482

(52) U.S. Cl. CPC G06F 3/0482

(57) ABSTRACT

Aspects of the subject technology include a device for assistive communication that includes a communication module and an analytics module. The communication module may present a first set of word tiles for selection, receive a first selected word tile from the first set of word tiles, present a second set of word tiles based on the first selected word tile from the first set of word tiles, receive a second selected word tile from the second set of word tiles, and generate a phrase based on the first selected word tile and second selected word tile. The analytics module may access the second selected word tile from the first set of word tiles, add the second selected word tile to a set of selections of a plurality of selections, and determine the second set of word tiles based on the plurality of selections.

### CROSS-REFERENCE TO RELATED APPLICATIONS

The present application claims the benefit of U.S. Provisional Patent Application Ser. No. 63/399,282, entitled “ASSISTIVE COMMUNICATION USING WORD TREES,” filed Aug. 19, 2022, which is hereby incorporated herein by reference in its entirety and made part of the present U.S. Utility patent application for all purposes.

### TECHNICAL FIELD

The present description generally relates to communication via electronic devices and, more particularly, to assistive communication devices, methods, and non-transitory mediums storing machine-readable instructions.

### BACKGROUND

Some individuals diagnosed with autism, global developmental delays (GDD), acquired brain injury (ABI), or progressive neurological diseases may suffer from a reduced ability to use vocal speech to communicate with others. Such individuals may use assistive communication tools, known as Augmentative and Alternative Communication (AAC) tools, to communicate. An AAC may encompass a variety of methods used to communicate, such as gestures, sign language, and picture symbols. An example of an AAC tool is a communication board in which the individual selects or points toward a picture on the communication board to convey a message to another person.

Some individuals may become accustomed to communicating through picture symbols at the expense of developing written communication skills and learned relations between pictures, text, and sound. For example, an individual may be capable of communicating to another person (e.g., a communication partner) that they are thirsty by pointing to a picture of water on a communication board, but the individual may be incapable of speaking or writing the word “water.”

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for communication sessions, in accordance with one or more implementations.

FIG. 2 depicts an example device with which aspects of the present disclosure may be implemented, in accordance with one or more implementations.

FIG. 3 depicts an example diagram of a word tree in which a word is selected per level of the word tree, in accordance with one or more implementations.

FIG. 4A depicts a schematic diagram of an example user interface presented by a device of a user, wherein a category is selected, in accordance with one or more implementations.

FIG. 4B depicts the schematic diagram of the example user interface of FIG. 4A, wherein a subcategory is selected, in accordance with one or more implementations.

FIG. 4C depicts the schematic diagram of the example user interface of FIG. 4B, wherein a word tree is selected, in accordance with one or more implementations.

FIG. 4D depicts the schematic diagram of the example user interface of FIG. 4C, wherein a word from the word tree is selected, in accordance with one or more implementations.

FIG. 4E depicts the schematic diagram of the example user interface of FIG. 4D, wherein an additional word from the word tree is selected, in accordance with one or more implementations.

FIG. 4F depicts the schematic diagram of the example user interface of FIG. 4E, wherein a phrase is generated, in accordance with one or more implementations.

FIG. 5 depicts a schematic diagram of an example user interface presented by a device of a communication partner, in accordance with one or more implementations.

FIG. 6 depicts an example progress chart representing the progress of the user, in accordance with one or more implementations.

FIG. 7 depicts a flow diagram of an example process for assistive communication, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Devices may be configured to operate as an AAC tool to assist users in communicating with other individuals. For example, a device may be configured to operate as a communication board in which the user selects a picture and/or word shown in a tile presented via a user interface to generate a phrase that the user would like to communicate. The user interface presented on the device may contain many tiles from which the user may select. However, this may only allow the user to communicate based on a narrow set of tiles.

In the subject technology, the user interface may be dynamic so that additional tiles may be presented to the user to allow for more effective and efficient communication. The words or phrases (collectively referred to herein simply as “words”) presented on a tile may be associated with a word tree. Selecting a tile associated with a word tree allows for the user interface to present another set of tiles that relate (e.g., logically, lexicographically, etc.) to the selected tile via the word tree so that the user's options for phrase construction are expanded without overwhelming the user. In addition, metrics relating to the tiles may be recorded to optimize the placement, arrangement, and/or the like to improve the efficacy and efficiency of the user's communication via the device.

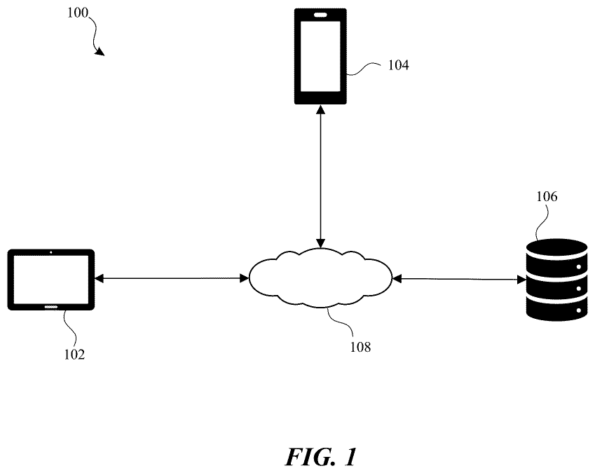

FIG. 1 illustrates a network environment 100 for communication sessions. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include a device 102, a device 104, and/or one or more servers such as a server 106. The network 108 may communicatively (directly or indirectly) couple the device 102, the device 104, and/or a server 106. In one or more implementations, the network 108 may be an interconnected network of devices that may include or may be communicatively coupled to the Internet. For explanatory purposes, the network environment 100 is illustrated in FIG. 1 as including the device 102, the device 104, and the server 106; however, the network environment 100 may include any number of devices and/or any number of servers communicatively coupled to each other directly or via network 108.

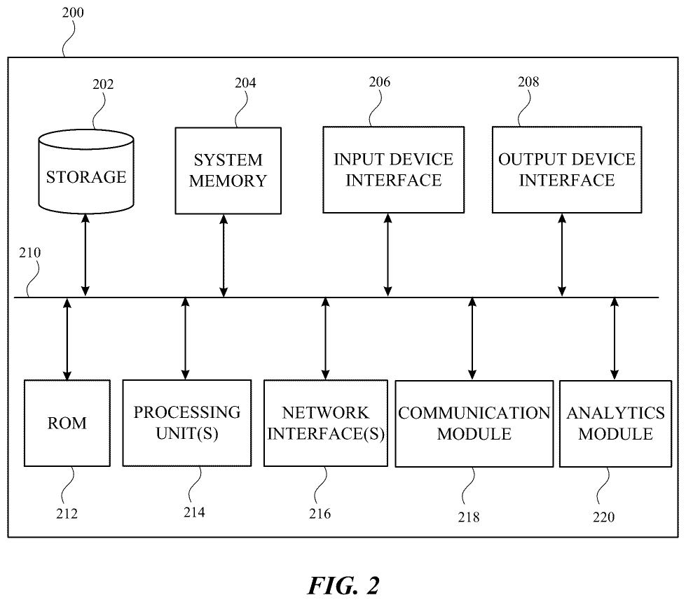

The device 102 may be, for example, a desktop computer, a portable computing device such as a laptop computer, a smartphone, a peripheral device (e.g., a digital camera, headphones), a tablet device, a wearable device such as a watch, a band, and the like, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the device 102 is depicted as a tablet. The device 102 may be, and/or may include all or part of, the electronic system discussed below with respect to FIG. 2. In one or more implementations, the device 102 may include a camera and a microphone and may provide a user interface for generating phrases by the selection of word tiles.

The device 104 may be, for example, a portable computing device such as a laptop computer, a smartphone, a peripheral device (e.g., a digital camera, headphones), a tablet device, a wearable device such as a watch, a band, and the like, any other appropriate device that includes, for example, one or more wireless interfaces, such as WLAN radios, cellular radios, Bluetooth radios, Zigbee radios, NFC radios, and/or other wireless radios. In FIG. 1, by way of example, the device 104 is depicted as a smartphone. The device 104 may be, and/or may include all or part of, the electronic system discussed below with respect to FIG. 2. In one or more implementations, the device 104 may include a user interface for tracking metrics about the user of the device 102.

In one or more implementations, one or more servers, such as the server 106, may perform operations for managing the secure exchange of user data and/or communication session data of and/or between various devices, such as the device 102 and/or the device 104. In one or more implementations, the server 106 may store account information associated with the device 102, the device 104, and/or users of those devices.

FIG. 2 depicts an example device 200 with which aspects of the present disclosure may be implemented, in accordance with one or more implementations. For explanatory purposes, FIG. 2 is primarily described herein with reference to the device 102 of FIG. 1. However, this is merely illustrative, and features of the device of FIG. 2 may be implemented in any other device for implementing the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The device 200 can be, and/or can be a part of, any device for generating the features and processes described in reference to FIGS. 1-7, including but not limited to a laptop computer, tablet computer, smartphone, and wearable device (e.g., smartwatch, fitness band). The device 200 may include various types of computer-readable media and interfaces for various other types of computer-readable media. The device 200 includes one or more processing unit(s) 214, a persistent storage device 202, a system memory 204 (and/or buffer), an input device interface 206, an output device interface 208, a bus 210, a ROM 212, one or more network interface(s) 216, and/or subsets and variations thereof.

The bus 210 collectively represents all system, peripheral, and chipset buses that communicatively connect the numerous internal devices of the device 200. In one or more implementations, the bus 210 communicatively connects the one or more processing unit(s) 214 with the ROM 212, the system memory 204, and the persistent storage device 202. From these various memory units, the one or more processing unit(s) 214 retrieves instructions to execute and data to process in order to execute the processes of the subject technology. The one or more processing unit(s) 214 can be a single processor or a multi-core processor in different implementations.

The ROM 212 stores static data and instructions that are needed by the one or more processing unit(s) 214 and other modules of the device 200. The persistent storage device 202, on the other hand, may be a read-and-write memory device. The persistent storage device 202 may be a non-volatile memory unit that stores instructions and data even when the device 200 is off. In one or more implementations, a mass-storage device (such as a magnetic or optical disk and its corresponding disk drive) may be used as the persistent storage device 202. In one or more implementations, a removable storage device (such as a floppy disk, flash drive, and its corresponding disk drive) may be used as the persistent storage device 202.

Like the persistent storage device 202, the system memory 204 may be a read-and-write memory device. However, unlike the persistent storage device 202, the system memory 204 may be a volatile read-and-write memory, such as RAM. The system memory 204 may store any of the instructions and data that one or more processing unit(s) 214 may need at runtime. In one or more implementations, the processes of the subject technology are stored in the system memory 204, the persistent storage device 202, and/or the ROM 212. From these various memory units, the one or more processing unit(s) 214 retrieves instructions to execute and data to process in order to execute the processes of one or more implementations.

The bus 210 also connects to the input device interface 206 and output device interface 208. The input device interface 206 enables a user to communicate information and select commands to the device 200. Input devices that may be used with the input device interface 206 may include, for example, alphanumeric keyboards, touch screens, and pointing devices (also called “cursor control devices”). The input device interface 206 may include sensors such as microphones, cameras, and/or the like.

The output device interface 208 may enable, for example, the display of images generated by device 200. Output devices that may be used with the output device interface 208 may include, for example, printers and display devices, such as a liquid crystal display (LCD), a light-emitting diode (LED) display, an organic light-emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 210 also couples the device 200 to one or more networks (e.g., the network 108) and/or to one or more network nodes through the one or more network interface(s) 216. In this manner, the device 200 can be a part of a network of computers (such as a LAN, a wide area network (“WAN”), an Intranet, or a network of networks, such as the Internet). Any or all components of the device 200 can be used in conjunction with the subject technology. The network interface 216 may include suitable logic, circuitry, and/or code that enables wired or wireless communication, such as between the device 102 and the server 106. The network interface 216 may include, for example, one or more of a Bluetooth communication interface, an NFC interface, a Zigbee communication interface, a WLAN communication interface, a USB communication interface, a cellular interface, or generally any communication interface.

The bus 210 also connects to the communication module 218 and the analytics module 220. The communication module 218 may be a hardware or software module configured to generate, store, and/or maintain word trees for presenting to the user, who may select words therefrom to create phrases. The analytics module 220 may be a hardware or software module configured to generate, store, and/or maintain metrics regarding the usage of words by the user for determining user progress, selecting sets of word tiles, arranging word tiles, and/or any the like. The communication module 218 and/or the analytics module 220 may be implemented in one or more other components of the device 200, such as the persistent storage device 202 and/or system memory 204.

In one or more implementations, one or more of one or more processing unit(s) 214, the system memory 204, the input device interface 206, the output device interface 208, the network interface 216, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

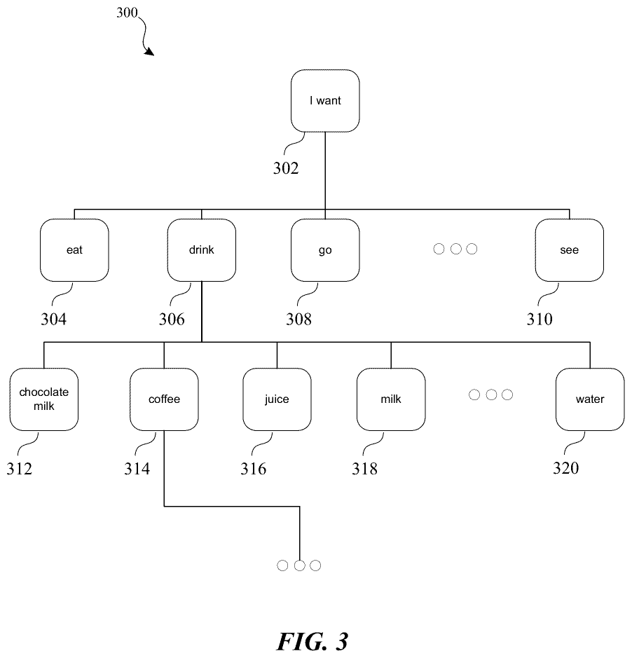

FIG. 3 depicts an example diagram of a word tree 300, in accordance with one or more implementations. The word tree 300 may comprise one or more levels. For example, the word tree 300 includes a first level having the word 302, a second level having the words 304, 306, 308, 310, a third level having the words 312, 314, 316, 318, 320, and so on. Each level of the word tree 300 comprises one or more words 302, 304, 306, 308, 310, 312, 314, 316, 318, 320. The words 302, 304, 306, 308, 310, 312, 314, 316, 318, 320 may be based on a particular subject. For example, the word tree 300 is based on activities, as shown by words 304, 306, 308, 310 (“eat,” “drink,” “go,” and “see,” respectively). The words of a level may be logically related to one or more words of one or more preceding levels. For example, words 312, 314, 316, 318, 320 are types of beverages because their parent is the word 306 (“drink”).

The word tree 300 may be manually and/or automatically constructed. For example, a communication partner may manually input and/or arrange words to construct the word tree 300, or a natural language processing model can restructure example sentences such that the words of the example sentences may represent the word tree 300. Additionally, each word of each level may represent another word tree (e.g., a subtree of word tree 300), which may be used along with one or more other word trees to create a new word tree. For example, one or more levels and words corresponding to the one or more levels following the word 308 (“go”) may be copied from its current location in the word tree 300 and pasted in a location in the word tree 300 after the word 314 (“coffee”) to expand the word tree 300 to specify where the user may want to drink coffee as the user has indicated by words 302, 306, 314. In some implementations, the words input to create the word tree 300 may be lemmatized before saving (e.g., to the persistent storage device 202). In such implementations, the selected words may be modified to be in an appropriate form when a phrase is generated so the phrase is grammatically correct.

As the user's communication ability improves, new words, such as adjectives or complex phrases, may be added to the word tree 300. This may be in response to detecting an improvement in the user's communication skills using metrics recorded during communication sessions, such as the complexity and diversity of words or phrases used by the user, the speed of phrase formation, or the user's ability to navigate deeper into the tree structure.

Additions to the word tree 300 may be made manually, by a communication partner, or automatically, using NLP techniques. For automatic additions, the natural language processing model could be trained to learn from a corpus of text, such as books, articles, or web content, identifying new words or phrases to add to the tree. The natural language processing model could also use information from the user's past communication sessions to identify new words or phrases that the user is likely to want to use in the future (e.g., based on similarity of the new words or phrases to the previously used words or phrases).

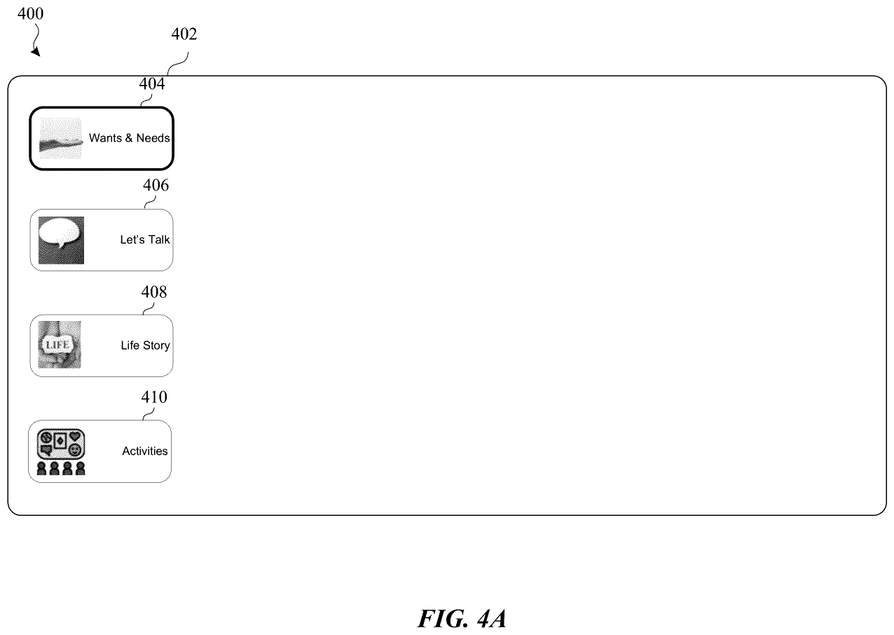

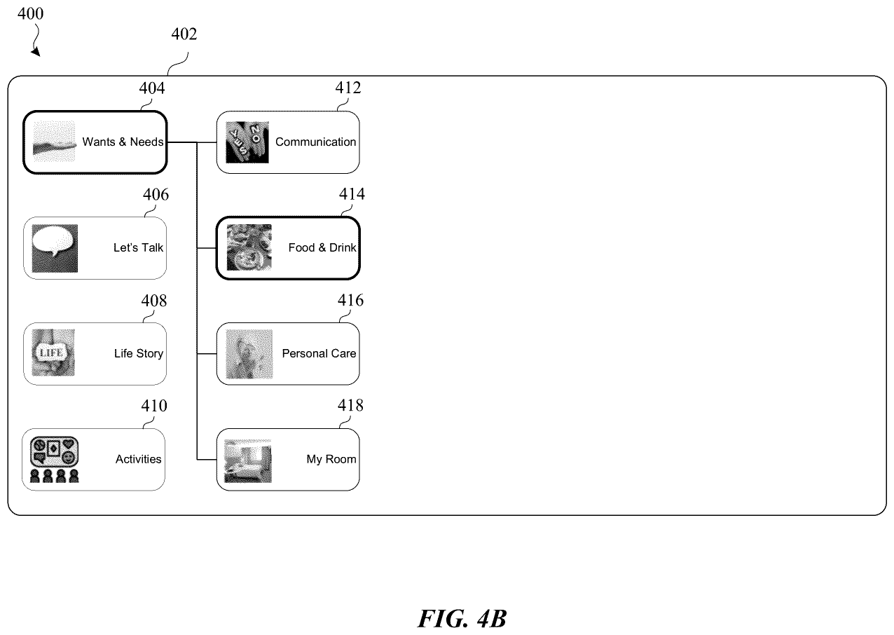

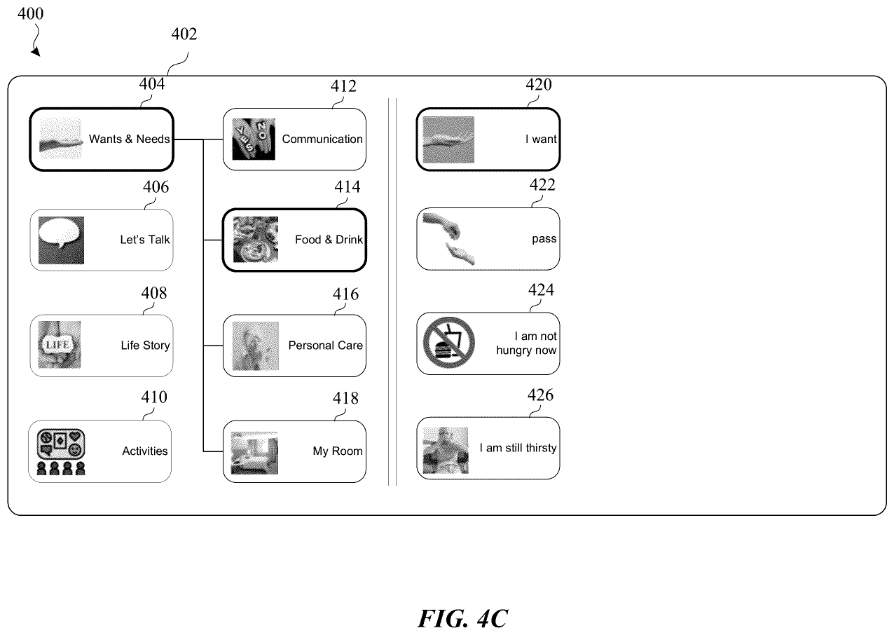

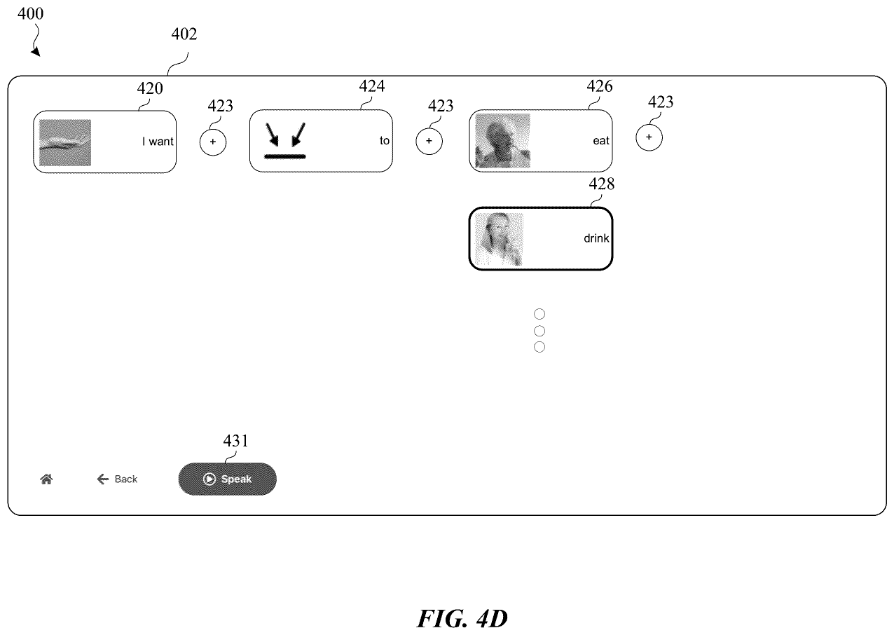

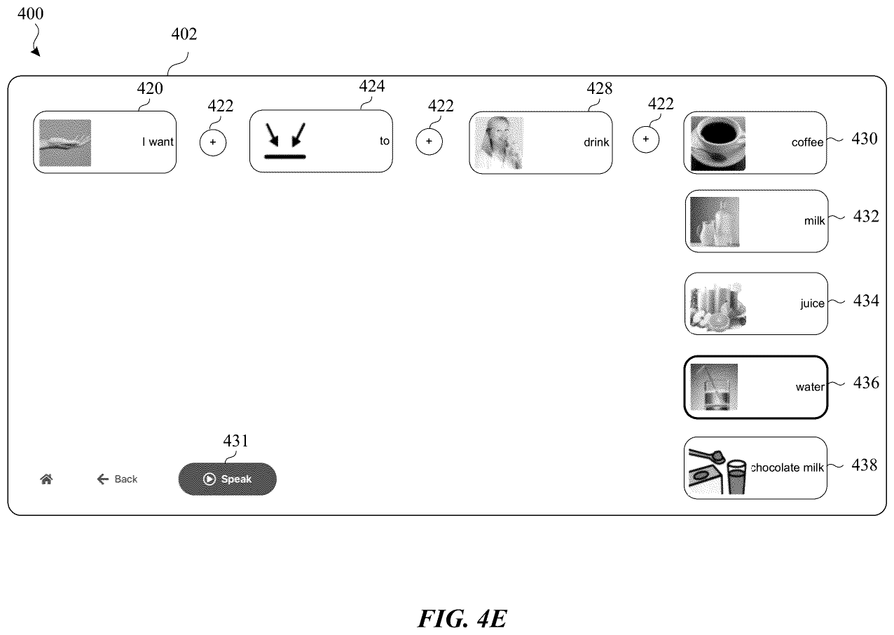

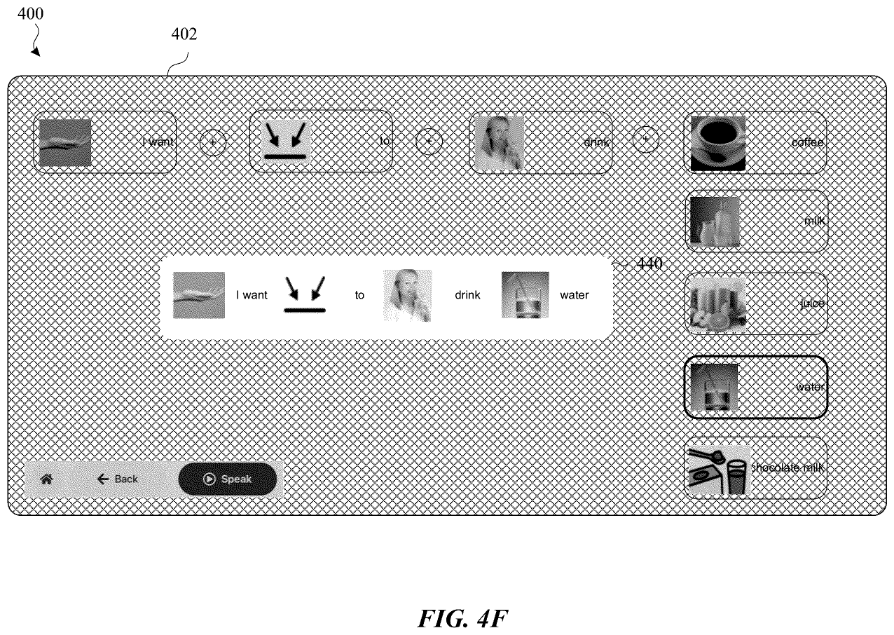

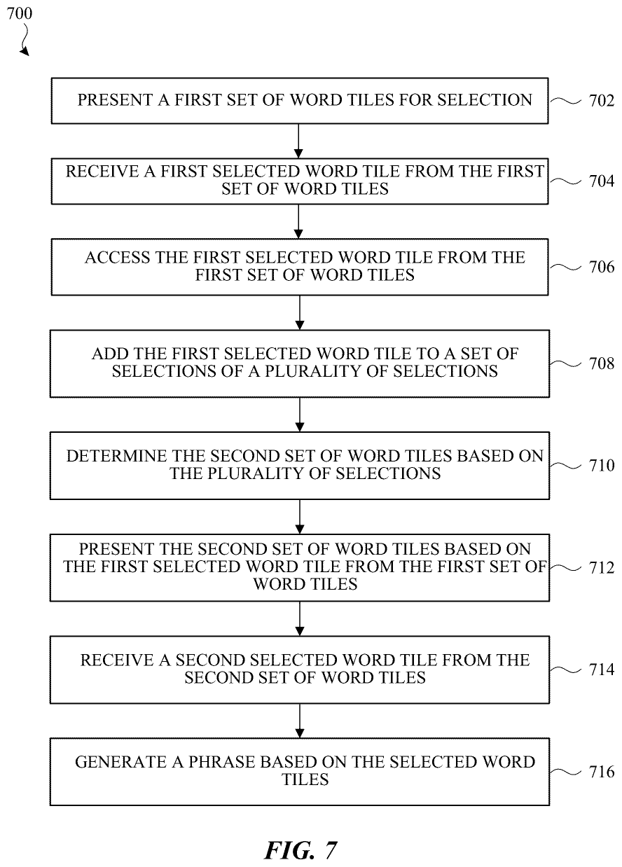

FIGS. 4A-4F depict a schematic diagram 400 of a user interface 402 of a process for a user to generate a phrase. The process is described in more detail with regard to FIG. 7. It is understood that FIGS. 4A-4F merely demonstrate how a user may interact with a device and how the device may respond to user interactions. Any depictions of FIGS. 4A-4F are not intended to be limiting and other visual representations are contemplated, including but not limited to other shapes, designs, arrangements, layouts, and/or the like.

FIG. 4A depicts a schematic diagram 400 of a user interface 402 presented (e.g., via the output device interface 208) by a device (e.g., the device 102) of a user. To help the user determine which word trees to select from, the user interface 402 may present the user with one or more categories 404, 406, 408, 410 of word trees. Selecting a category 404, 406, 408, 410 may narrow the number of word trees available to the user to those that include words belonging to the selected category. Organizing the available word trees by category 404 may improve the efficiency of using the device as the user will not have to go through each word tree and may improve engagement with the user interface 402 as the user will not be overwhelmed by the options available. The word trees may be categorized manually or automatically. For example, a communication partner may determine which categories each word tree should belong to, or a machine learning algorithm may classify each word tree based on the words included in the word tree. In some implementations, the categories 404, 406, 408, 410 may be represented as tile-shaped display elements on the user interface 402. The tile-shaped display elements may include an image corresponding to the category of the display element to provide the user with a visual cue of the category. It is understood that selecting a category of word trees is not a necessary step for the present technology.

In some implementations, the device may receive audio data (e.g., via a microphone) of another person speaking to the user. Based on the audio data, the device may select or recommend a category of word tree to help the user navigate the user interface 402.

FIG. 4B depicts the schematic diagram 400 of the user interface 402 of FIG. 4A. To help the user further determine which word trees to select from, the user interface 402 may also present the user with one or more subcategories 412, 414, 416, 418 based on the selected category 404, 406, 408, 410. The subcategories 412, 414, 416, 418 may be logically related to their corresponding category. Similar to the categorizations, subcategories may be generated manually or automatically. For example, a communication partner may determine which subcategories each word tree should belong to, or a machine learning algorithm may classify each word tree based on the words included in the word tree. In some implementations, the subcategories 412, 414, 416, 418 may be represented as tile-shaped display elements on the user interface 402. The tile-shaped display elements may include an image corresponding to the category of the display element to provide the user with a visual cue of the subcategory. It is understood that selecting a subcategory of word trees is not a necessary step for the present technology.

In some implementations, the device may receive audio data (e.g., via a microphone) of another person speaking to the user. Based on the audio data, the device may select or recommend a subcategory of word tree to help the user navigate the user interface 402.

FIG. 4C depicts the schematic diagram 400 of the user interface 402 of FIG. 4B. From the user interface 402, the user may select a word from a first set of words 420, 422, 424, 426 represented as tile-shaped display elements (also referred to herein as “word tiles”). The tile-shaped display elements may also or instead include an image corresponding to each word of the first set of words 420, 422, 424, 426. When the word of the first set of words 420, 422, 424, 426 is selected, the word may be read aloud by the user's device (e.g., the output device interface 208 of device 200). It is understood that although the display elements are referred to as including “words,” “words” may be one or more words.

For example, the user may be presented with the first set of words 420, 422, 424, 426 on a device (e.g., the device 102). The user may then select the word 420 (“I want”), which is received by the user's device. The user's device may store the selection and may determine the second set of words based on the selection. To determine the second set of words, the user's device may identify a word tree corresponding to the word 420 (e.g., word tree 300) and generate tile-shaped display elements for the user interface 402 corresponding to words that are children of word 420 on the word tree (e.g., words 304, 306, 308, 310).

In some implementations, the first set of words 420, 422, 424, 426 may be organized in a particular fashion. The organization may be rules-based, such as alphabetical. The organization may also or instead be predictive. For example, the organization may be based on the frequency of usage of words, the likelihood of usage of words, and/or the like as explained in more detail with respect to FIG. 7.

In some implementations, the device may receive audio data (e.g., via a microphone) of another person speaking to the user. Based on the audio data, the device may select or recommend a subcategory of word tree to help the user navigate the user interface 402.

FIG. 4D depicts the schematic diagram 400 of the user interface 402 of FIG. 4C. From the user interface 402, the user may select a word from a second set of words 426, 428 represented as tile-shaped display elements. It is understood that the second set of words 426, 428 may be represented in any form of display elements. The second set of words 426, 428 may be from the same word tree as the word 420 selected in FIG. 4C and may be children (e.g., words 304, 306) of the word 420.

In some implementations, the second set of words 426, 428 may be organized in a particular fashion. The organization may be rules-based, such as alphabetical. The organization may also or instead be predictive. For example, the organization may be based on the frequency of usage of words, the likelihood of usage of words, and/or the like as explained in more detail with respect to FIG. 7.

In some implementations, after a first and/or second word is selected (e.g., word 302 and/or word 428), the device may insert one or more words between them. For example, when the user selects the word 428, the device may automatically add the word 424 (“to”) between them. Adding words such as word 424 may make the phrase more grammatically correct without burdening the user to insert words, such as prepositions or particles. In some implementations, the device may wait until a user has indicated that they are finished selecting words (e.g., by interacting with the button 431) before inserting words (e.g., the word 424).

In some implementations, the user may insert one or more additional words. The user interface 402 may include one or more insert buttons 423. A user may interact with an insert button 423 to insert a word at the location corresponding to the insert button 423. For example, the user may interact with the insert button between the word 420 and the words 426, 428 so select, type, or otherwise input another word, such as the word 424.

In some implementations, the device may receive audio data (e.g., via a microphone) of another person speaking to the user. Based on the audio data, the device may select and recommend the word (and/or one or more subsequent words) to help the user navigate the user interface 402. In some implementations, the selection may be based on prior usage data. For example, the device may be more likely to select a word that has used most frequently over a period of time or most recently.

FIG. 4E depicts the schematic diagram 400 of the user interface 402 of FIG. 4D. Similar to FIG. 4D, the user may select a word from a third set of words 430, 432, 434, 436, 438 represented as tile-shaped display elements. It is understood that the third set of words 430, 432, 434, 436, 438 may be represented in any form of display elements. The third set of words 430, 432, 434, 436, 438 may be from the same word tree as the word 420 selected in FIG. 4C and may be children (e.g., words 312, 314, 316, 318, 320) of the word 428. In some implementations, the third set of words 430, 432, 434, 436, 438 may be from a word tree in which the word 428 is selected in FIG. 4D is the root node and the third set of words 430, 432, 434, 436, 438 are the children of the word 428.

FIG. 4F depicts the schematic diagram 400 of the user interface 402 of FIG. 4E. The user interface 402 may include a speak button 431. An interaction with the speak button 431 may indicate that the user has completed their word selection. When there is an interaction with the speak button 431, the user's device may generate (or cause to be generated, for example, by sending information to a server) a phrase 440 based on the selected (and/or inserted) word tiles (e.g., words 420, 424, 428). The user's device may also or instead generate communication data for output, such as text data for the user to read the phrase and audio data for the user to hear the phrase. In some implementations, there may be a delay between generating the phrase 440 and outputting a corresponding communication data. For example, there may be a period of seconds between when the phrase 440 appears for the user to read and when the user's device reads the phrase 440 for the user to give the user an opportunity to attempt to read the phrase 440.

In some implementations, the device may receive audio data (e.g., via a microphone) of another person speaking to the user. Based on the audio data, the device may automatically select a word tree group and/or one or more words, to automatically generate and suggest the phrase 440 to the user. In some implementations, the device may automatically navigate through the user interface 402 to select the word tree group and/or one or more words to reduce the cognitive load on the user. In some implementations, the device may automatically generate and suggest multiple phrases to the user, which the user name select to respond to the other person speaking to the user.

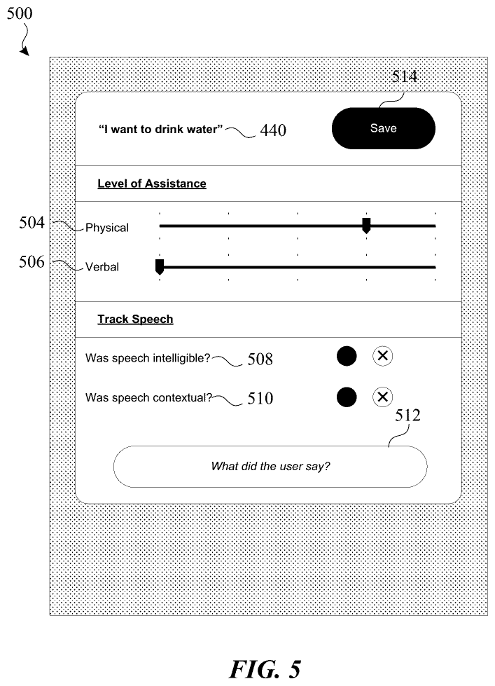

FIG. 5 depicts a user interface 500 presented by a device of a communication partner. The communication partner may have a device (e.g., the device 104 or the device 102) for tracking the user's progress. The device may present the communication partner with the user interface 500, which may include the phrase 440.

The user interface 500 may also include one or more metrics by which the communication partner may evaluate the user. One category of metrics the communication partner may track is the level of assistance the user had in communicating. For example, the communication partner may track a physical level of assistance 504 and/or a verbal level of assistance 506. Another category of metrics the communication partner may track is the quality of speech. For example, the communication partner may track speech intelligibility 508 and/or speech contextuality 510. In some implementations, the communication partner may also input in the input field 512 what the user actually said.

When the communication partner has completed evaluating a particular instance of communication, the communication partner may interact with the save button 514 to store the data (e.g., in an analytics module 220). The data generated by the communication partner via the user interface 500 may be used, for example, to generate progress charts, modify the arrangement of word tiles displayed to the user, modify the timing between receiving a selected word and outputting a corresponding communication data, expand or prune the relevant word trees, and/or the like. It is understood that metrics are not limited to those shown in FIG. 5 nor are metrics limited to being tracked in the format (e.g., sliding scale and radio buttons) shown in FIG. 5.

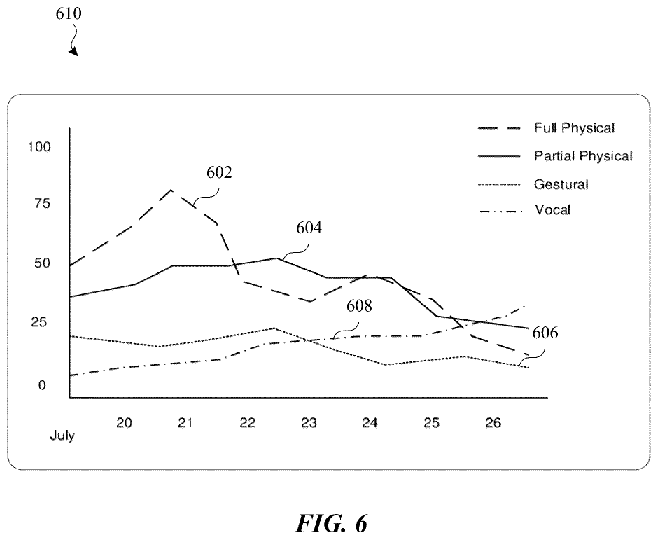

FIG. 6 depicts an example progress chart 610 representing progress of the user. The progress chart 610 may display a user's progress using a communication application to construct phrases based on data tracked by the communication partner. The progress chart 610 indicates the number of instances in which different forms of assistance were provided by a communication partner throughout a period of time. The progress chart 610 may be generated by interaction data collected as discussed herein and may be consulted to review the progress of the individual.

As shown, for example, the dashed line 602 represents the number of instances in which the user was provided with full physical assistance, the solid line 604 represents the number of instances in which the user was provided with partial physical assistance, the dotted line 606 represents the number of instances in which the user was provided with gestural assistance, and the dash-dotted line 608 represents the number of instances in which the user was provided with vocal assistance.

As can be seen, the frequency that the user received full physical assistance, partial physical assistance, and gestural assistance, has fallen over time, while the frequency that the user received vocal assistance has increased slightly. Such information may inform a communication partner of the user's progress and allow the communication partner to adapt their care strategy accordingly.

In some implementations, the information may also be used to modify the arrangement of word tiles displayed to the user, modify the timing between receiving a selected word and outputting a corresponding communication data, and/or other aspects of the user's experience with the device to further improve the usability of the subject technology and the user's overall progress.

In some implementations, one or more word trees may be modified responsive to the user's progress. One or more word trees may be grown when the progress chart 610 indicates that the user is making progress in their communication abilities, for example, when the levels of assistance over time are decreasing over a period of time. The one or more word trees may include those that were used in instances corresponding to higher levels of assistance. Growing such words trees may include adding one or more words to one or more levels of a word tree (e.g., to provide the user more options from which to choose), adding one or more levels of words to a word tree (e.g., to allow the user to create longer phrases), replacing one or more words in a word tree (e.g., with more complex language), and the like.

In some implementations, one or more word trees may also or instead be pruned when the progress chart 610 indicates that the user is not making progress or is regressing in their communication abilities, for example, when the levels of assistance over time are steady or increasing over a period of time. The one or more word trees may include those that were used in instances corresponding to levels of assistance that are steady or increasing. Pruning such words trees may include remove one or more words from one or more levels of a word tree (e.g., to provide the user fewer options from which to choose), removing one or more levels of words from a word tree (e.g., to keep the user's phrases shorter), replacing one or more words in a word tree (e.g., with more simplified language), and the like.

FIG. 7 depicts a flow diagram of a process 700 for using a device for assistive communication. For explanatory purposes, the process 700 is primarily described herein with reference to the devices of FIG. 1. However, the process 700 is not limited to the devices of FIG. 1, and one or more blocks (also referred to as steps or operations) of the process 700 may be performed by one or more other components of the device 102 and/or by other suitable devices. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, a first set of word tiles may be presented for selection. A device (e.g., the device 102) may present the first set of word tiles on a user interface via an electronic display (e.g., the output device interface 208). The word tiles may be user interface elements in the user interface, each including a word or set of words from a word tree. In some implementations, each word tile of the first set of word tiles may correspond to a word tree having the respective word tile as its root node.

Word tiles may also include other visual elements (e.g., image or color) to assist the user in determining or remembering the word of a word tile or aspects thereof, such as usage or pronunciation. Word tiles may be list items, blocks, buttons, fields, selectors, or any other user interface element capable of displaying at least a word. Although referred to as word tiles, it is understood that the word tiles are not limited to tile-shaped display elements.

At block 704, a first selected word tile for the first set of word tiles may be received. The user may select a word tile via the user interface via the electronic display (e.g., via the input device interface 206). The user may touch the word tile on a touch screen, click the word tile with a cursor control device, and/or perform any other action for selecting a word tile.

At block 706, the first selected word tile from the first set of word tiles may be accessed. The first selected word tile may be accessed so that the analytics module may monitor usage of word tiles and/or influence the set of tiles presented to the user. The device may access the first selected word tile, such as, by receiving the user's selection (e.g., from the input device interface 206) or retrieving the word tile from memory (e.g., a buffer). For example, the first selected word tile may be placed into a buffer (e.g., in system memory 204) that may track the user's selection of word tiles and increment a counter that tracks the frequency of use of the first selected word tile. Accessing the first selected word tile may also include retrieving one or more word trees associated with the first selected word tile. For example, because the selected word tile is the first selected word tile, the device may retrieve a word tree having the first selected word tile as the root node of the tree.

At block 708, the first selected word tile is added to a set of selections of a plurality of selections. To determine the usage history of a word, the device (e.g., the analytics module 220) may maintain a record of a plurality of selections over a period of time for the user and/or multiple users. The plurality of selections may be a list of selections or a collection of sets of selections, where a set of selections is the selected word tiles in a particular session. For example, the device may create a database (e.g., in the persistent storage device 202) storing selections of word tiles from previous sessions and a buffer (e.g., in the system memory 204) storing selections of word tiles from the current session, which may be transferred to the database after the session is complete.

At block 710, the second set of word tiles may be determined. Word tiles may be organized into word trees so that the selection of one word tile may generate an additional group of word tiles for selection by the user. Word trees (e.g., word tree 300) may be a tree data structure in which each node is a word or set of words that may be placed into a user interface element (e.g., word tile) for user selection. Word trees may be structured with n levels such that a root node (e.g., 302) is the sole node at a first level having child nodes (e.g., words 304, 306, 308, 310) at a succeeding level, leaf nodes (e.g., words 312, 314, 316, 318, 320) are nodes at an nth level having parent nodes at a preceding level, and the remaining nodes may be children and/or parents of other nodes at a level between 1 and n. The nodes at succeeding levels may be words that logically follow from a node at any given level.

Accordingly, the first selected word tile may correspond to a first word tree (e.g., accessed at block 706) in which the first selected word tile may be the root node of the first word tree, and the second set of word tiles may be the nodes at the level of the first word tree following the node corresponding to the first selected word tile. In other words, determining the second set of word tiles may include identifying a word tree having the first selected word tile in its first level and the second selected word tile in its second level. For example, the first selected word tile “I want” may be a root node that is a parent of nodes for “Eat,” “Drink,” and “Item,” which are word tiles that represent logical ideas that could follow “I want” and may be used to form a second set of word tiles.

In some implementations, the device may predict a likelihood of selection for one or more word tiles of the second set of word tiles. The prediction may be based on the plurality of selections (e.g., selections of word tiles over a period of time across one or more users). With the prediction, the second set of word tiles may be arranged, filtered, prioritized, or otherwise modified according to their likelihood of selection.

For example, to predict the likelihood of selection, the analytics module of the device may be configured to perform statistical algorithms, machine learning algorithms, natural language processing algorithms, and/or the like. For example, a natural language processing algorithm may include a natural language processing model that is trained to generate a likelihood of a word tile from the second set of word tiles following the first selected word tile based at least in part on an annotated corpus. The annotated corpus may be a body of text where each word is annotated with a subsequent word. The natural language processing model may receive as input the first selected word tile and one or more word tiles from the second set of word tiles and generate as output a likelihood for each of the one or more word tiles that each respective word tile follows the first selected word tile

Predicting the likelihood of selection may also or instead be based on a frequency of one or more word tiles of the second set of word tiles in the plurality of selections. For example, the analytics module may select the word tiles that have been most commonly selected by the user in the past, which may change over time. As another example, the natural language processing model may be further trained based on the frequency of use of one or more word tiles of the second set of word tiles.

Predicting the likelihood of selection may also or instead be based on situational cues. The usage of some words may be dependent on context, such as the location of the user, the time of day, the user's recent activity, and/or other situational cues. For example, the device may determine its current location (e.g., a restaurant), for example, based on its network address (e.g., from the network interface 216), and increase the likelihood of use of particular words (e.g., food items) based on its current location.

Based on the likelihood of selection, the analytics module may prioritize one or more word tiles of the second set of word tiles such that a word tile with the highest likelihood of selection has the highest priority. Having a higher priority may result in being presented sooner to a user, having additional user interface elements (e.g., highlighting), and/or other modifications to the user interface to emphasize word tiles with higher priorities compared to word tiles with lower priorities.

At block 712, the second set of word tiles may be presented to the user. The device may present the second set of word tiles in a manner similar to the first set of word tiles (e.g., on the user interface via the electronic display). The second set of word tiles may replace the first set of word tiles on the user interface.

Before presenting the second set of word tiles, the device may preprocess the second set of word tiles. Preprocessing the second set of word tiles may include ordering, arranging, optimizing, resizing, and/or any other kind of modification to the word tiles before and/or after presenting the second set of word tiles to the user.

At block 714, the second selected word tile from the second set of word tiles may be received. The second selected word tile may be received in a manner similar to the first selected word tile as described with regard to block 704. Blocks 710-714 may be repeated to determine, present, and/or receive additional word tiles. It should thus be understood that although the subject technology is described with regard to two word tiles, the use of more or less than two word tiles is contemplated (e.g., as shown in FIG. 4E).

At block 716, a phrase may be generated based on the selected word tiles. A phrase may include one or more sentences, including at least the selected word tiles. For example, the phrase may simply be a sentence that combines the selected word tiles. In some implementations, the communication module may automatically fill in parts of speech to complete the phrase based on the selected word tiles by inserting syntactically appropriate prepositions, pronouns, particles, and/or the like. For example, if the user selects word tiles “I want” and “outside,” the generated phrase may be “I want to go outside.” In some implementations, generating the phrase may include providing the selected word tiles as input to a machine learning model that is trained to generate a complete sentence based at least in part on sentence fragments (e.g., the selected word tiles).

The communication module may also generate communication data for output based on the generated phrase. The communication data may include a string data structure for presenting the phrase to the user, audio data for reading the phrase to the user, a data packet for transmitting the phrase to other devices (e.g., the communication partner's device), and/or any other data format and output action.

In some implementations, the device may also include a training module. The training module may receive interaction data, including levels of assistance (e.g., physical and/or verbal) the user had to read the phrase and the quality of the user's reading of the phrase (e.g., intelligibility and/or contextuality). The training module may receive the interaction data from a communication partner manually tracking the interaction data and/or from a device (e.g., the user's device) that captures audio from the user (e.g., via a microphone) and processes the audio. The interaction data may include interactions by the user with the device over a plurality of instances. The training module may also generate progress metrics (e.g., progress chart 610) for tracking the progress of the user, which may include, for example, the change in assistance to the user over a period of time.

Based on the progress of the user, the device may add or increase a delay time, based on the interaction data, between receiving a selected word and outputting a corresponding communication data. For example, as the user receives less assistance saying a particular word, a delay time may be added between when the user selects the word and when audio of the word is played by the device to give the user more opportunity to independently read the word. Similarly, as the user receives less assistance saying a particular sentence, a delay time may be added between when the sentence is presented to the user and when audio of the sentence is played by the device to give the user more opportunity to independently read the sentence.

Based on the progress of the user, the device may also or instead grow or prune one or more word trees to adapt to the user. For growth of one or more word trees, the device may employ various NLP techniques such as Word2Vec, GloVe, or fastText to map words into a semantic space via word embeddings based on their co-occurrence with other words in the corpus. By analyzing the word embeddings, the device may identify semantically related words to add to the tree. Some implementations may involve setting a frequency threshold such that if a word is used above a certain frequency, the device may then add related words or phrases to the corresponding branch and/or level of the relevant word tree, which would allow for more contextually relevant and diverse communication options for the user. Additionally or alternatively, a rule-based system may be used to add words based on grammatical patterns. For instance, if the word “water” is often used with verbs like “drink” and “pour,” the system could add more verbs that are semantically related to this context.

In contrast, the pruning of one or more word trees may be triggered when it is determined that the current complexity of a word tree exceeds the user's cognitive abilities, such as the complexity (e.g., length, difficulty, and the like) of the phrases they can construct. For example, a word tree may exceed the user's cognitive abilities if the user is only able to construct two- or three-word phrases independently and consistently, but the word tree is designed for constructing full sentences. Other variables that may indicate the user's cognitive abilities may include the user's response time, error rate, and/or the amount of assistance required for communication. For example, if the user's response time and/or error rate exceeds the set threshold for each, the pruning process may be triggered. Pruning may include removing less frequently used words or phrases, simplifying the structure of certain branches/levels, or reducing the depth of the tree (e.g., limiting the number of levels for each branch). Pruning may also or instead employ clustering algorithms to identify and group rarely used words and decide on their removal.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it is understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on a device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

What is claimed is:

1. A device for assistive communication, comprising:
a communication module configured to perform operations comprising presenting a first set of word tiles for selection, receiving a first selected word tile from the first set of word tiles, presenting a second set of word tiles based on the first selected word tile from the first set of word tiles, receiving a second selected word tile from the second set of word tiles, and generating a phrase based on the first selected word tile and the second selected word tile; and
an analytics module configured to perform operations comprising accessing the first selected word tile from the first set of word tiles, adding the first selected word tile to a set of selections of a plurality of selections, and determining the second set of word tiles based on the plurality of selections.

2. The device of claim 1, wherein the communication module is configured to perform operations further comprising, before presenting the first set of word tiles for selection, identifying a word tree for each word tile of the first set of word tiles, wherein each word tree has the corresponding word tile in its first level.

3. The device of claim 2, wherein presenting the second set of word tiles for selection comprises presenting a set of word tiles at a second level of the word tree corresponding to the first selected word tile from the first set of word tiles.

4. The device of claim 2, wherein determining the second set of word tiles for selection comprises identifying a word tree having the first selected word tile from the first set of word tiles in its first level and the second selected word tile from the second set of word tiles in its second level.

5. The device of claim 1, wherein generating the phrase comprises providing the first selected word tile and second selected word tile as input to a machine learning model that is trained to generate a complete sentence based at least in part on sentence fragments.

6. The device of claim 1, wherein the communication module further comprises generating a communication data for output based on the phrase.

7. The device of claim 1, wherein determining the second set of word tiles comprises predicting a likelihood of selection for one or more word tiles of the second set of word tiles based on the plurality of selections and prioritizing the one or more word tiles of the second set of word tiles based on the likelihood of selection such that a word tile with the highest likelihood of selection has the highest priority.

8. The device of claim 7, wherein predicting the likelihood of selection is further based on a frequency of one or more word tiles of the second set of word tiles in the plurality of selections.

9. The device of claim 7, wherein predicting the likelihood of selection is further based on a current location.

10. The device of claim 7, wherein predicting the likelihood of selection comprises providing the first selected word tile from the first set of word tiles and one or more word tiles from the second set of word tiles as input to a natural language processing model that is trained to generate a likelihood of a word tile from the second set of word tiles following the first selected word tile based at least in part on an annotated corpus.

11. The device of claim 1, further comprising a training module configured to perform operations comprising collecting interaction data and progressively increasing a delay time between receiving a selected word and generating a phrase for output based on the interaction data.

12. The device of claim 11, wherein the interaction data comprises interactions by a user with the device over a plurality of instances.

13. A method comprising:
presenting, by a communication module, a first set of word tiles for selection;
receiving, by the communication module, a first selected word tile from the first set of word tiles;
accessing, by an analytics module, the first selected word tile from the first set of word tiles;
adding, by the analytics module, the first selected word tile to a set of selections of a plurality of selections;
determining, by the analytics module, a second set of word tiles based on the plurality of selections;
presenting, by the communication module, the second set of word tiles based on the first selected word tile from the first set of word tiles;
receiving, by the communication module, a second selected word tile from the second set of word tiles; and
generating, by the communication module, a phrase based on the first selected word tile and the second selected word tile.

14. The method of claim 13, further comprising, before presenting the first set of word tiles for selection, identifying a word tree for each word tile of the first set of word tiles, wherein each word tree has the corresponding word tile in its first level.

15. The method of claim 14, wherein determining the second set of word tiles comprises identifying a set of word tiles at a second level of the word tree corresponding to the first selected word tile from the first set of word tiles.

16. The method of claim 13, wherein determining the second set of word tiles comprises predicting a likelihood of selection for one or more word tiles of the second set of word tiles based on the plurality of selections and prioritizing the one or more word tiles of the second set of word tiles based on the likelihood of selection such that a word tile with the highest likelihood of selection has the highest priority.

17. A non-transitory medium storing machine-readable instructions that, when executed by a processor, cause the processor to perform operations comprising:
presenting, by a communication module, a first set of word tiles for selection;
receiving, by the communication module, a first selected word tile from the first set of word tiles;
accessing, by an analytics module, the first selected word tile from the first set of word tiles;
adding, by the analytics module, the first selected word tile to a set of selections of a plurality of selections;
determining, by the analytics module, a second set of word tiles based on the plurality of selections;
presenting, by the communication module, the second set of word tiles based on the first selected word tile from the first set of word tiles;
receiving, by the communication module, a second selected word tile from the second set of word tiles; and
generating, by the communication module, a phrase based on the first selected word tile and the second selected word tile.

18. The non-transitory medium of claim 17 storing machine-readable instructions that cause the processor to perform operations further comprising, before presenting the first set of word tiles for selection, identifying, by the communication module, a word tree for each word tile of the first set of word tiles, wherein each word tree has the corresponding word tile in its first level.

19. The non-transitory medium of claim 18, wherein determining the second set of word tiles comprises identifying a set of word tiles at a second level of the word tree corresponding to the first selected word tile from the first set of word tiles.

20. The non-transitory medium of claim 17, wherein determining the second set of word tiles comprises predicting a likelihood of selection for one or more word tiles of the second set of word tiles based on the plurality of selections and prioritizing the one or more word tiles of the second set of word tiles based on the likelihood of selection such that a word tile with the highest likelihood of selection has the highest priority.
